(19) United States
(12) Patent Application Publication
(10) Pub. No.: US 2002/0129491 A1
(43) Pub. Date: Sep. 19, 2002

(54) Small footprint direct drive mechanical positioning stage

(75) Inventors: Stephen J. Botos, Pittsburgh, PA (US); Brian L. Favero, New Kensington, PA (US)

Correspondence Address: David C. Hanson, WEBB ZIESENHEIM LOGSDON ORKIN & HANSON, P.C., 700 Koppers Building, 436 Seventh Avenue, Pittsburgh, PA, 15219, US

(73) Assignee: Aerotech, Inc.,, Pittsburgh, PA

(21) Appl. No.: 09/812,241

(22) Filed: Mar. 19, 2001

(51) Int. Cl. B23P 21/00

(52) U.S. Cl. 29/714

(57) ABSTRACT

A small footprint mechanical positioning stage capable of operating in two perpendicular orientations comprises a base plate, a carriage plate, linear bearings, a brushless linear motor, and a linear encoder. The linear bearings, the linear motor and the encoder scale are all parallel to the direction of travel of the positioning stage.

### FIELD OF THE INVENTION

This invention relates to the field of direct drive mechanical stages for precision motion control. More specifically, it relates to small footprint linear motor driven positioning stages useful in the alignment of optic fibers.

### BACKGROUND OF THE INVENTION

Optic fibers are being used more and more for the transfer of information due to the large bandwidth and insensitivity to certain types of electromagnetic interference. Optic fibers are transparent glass fibers through which light waves encoded with information are passed. The fibers themselves are often less than 100 nm in diameter. Typically, they are enclosed in a protective coating. The fibers are not infinitely long and, therefore, it is necessary to align and bond fibers together. The alignment must be very precise, that is, the centers of the fibers must be aligned in order to minimize power loss across a bonded joint. Not only must fibers be joined end to end, fibers must be connected to tiny components, such as transmitters, amplifiers and receivers. This process is referred to in the industry as pig-tailing.

In order to position fibers for fiber-to-fiber bonding or pig-tailing automatically, mechanical positioning stages with extremely high resolution and repeatability are required. Very often the bonding and pig-tailing take place in clean rooms. The expense of building and maintaining clean rooms is directly related to the volume of the room. Hence, miniaturization of the mechanical positioning stages for use in optic fiber alignment is extremely critical.

The extent of the motion required to execute the final fiber alignment is on the order of 100's of microns. This is due to the relatively small size of the fiber itself. Core diameters vary from 200 microns for multi-mode fibers down to 9 microns for single-mode fibers. The relative small distances required to align the fibers are dwarfed by the size of even the smallest positioning stages now in successful use.

The smallest possible alignment stage volume is currently attainable with stages driven by piezoelectric crystals mounted in structures known in the art as flexures. These tools have limited maximum travel. This lack of travel has necessitated the use of a combination of a coarse positioning stage (millimeters of travel) with a piezoelectric flexure stage if a movement greater than about 200 microns is required for the initial alignment and/or transferring to a position for final alignment. One marketed stage system for fiber alignment uses piezoelectric flexures for the X and Y axes and a ball screw driven stage for the vertical axis. The ball screw drive is a mechanical contact driven device subject to wear. Also, the footprint is 4 inches by 7 inches. Yet another marketed system for this application is entirely ball screw driven having a footprint of about 4.5 inches by 4 inches. It is, of course, inherently subject to the problems of mechanical wear and the backlash associated with ball screw driven stages. Perhaps the most successful stage now being marketed is entirely driven by noncontact permanent magnet linear motors. Due to the design of the motors and other factors, the size of the footprint is still a relatively large 5 inches by 7 inches.

Footprint and travel ranges are not the only criteria for selection of a positioning stage for fiber alignment applications. Speed, accuracy, repeatability and positioning stability are also very critical.

It is an advantage, according to the present invention, to provide a small footprint linear motor driven positioning stage that has a combination of a small footprint, a long travel range, high speed, high accuracy, high repeatability and high position stability that make it a superior choice for fiber alignment applications.

### SUMMARY OF THE INVENTION

Briefly, according to the present invention, there is provided a small footprint mechanical positioning stage capable of operating in two perpendicular orientations. The stage comprises a base plate comprising a flat bed, a short platform rising from the bed near one edge of the bed, and a short perpendicular wall rising from the bed near an opposite edge of the bed. The stage further comprises a carriage plate comprising a flat table plate and a short side wall pendent from the table plate near one edge of the table plate.

A first linear bearing is positioned between the base plate and the carriage plate fixed to the platform rising from the flat bed and a second linear bearing is positioned between the base plate and the carriage plate fixed to the wall rising from the flat bed and the wall pendent from the carriage plate. The first linear bearing provides maximum support in the direction perpendicular to the flat bed and the table plate and the second linear bearing provides maximum support in the direction between edges of the flat bed and table plate parallel to the direction of travel of the stage. This enables the use of the stage in two perpendicular orientations.

A brushless linear motor comprises an armature winding fixed to the base plate having a magnetic focusing plate between the armature winding and the base plate and a rare earth magnet track fixed to the table plate having a magnetic focusing plate between the magnet track and the table plate. A linear encoder reader is fixed to the flat bed and an encoder scale is fixed to the table plate.

The first and second linear bearings, the linear motor, and the encoder scale are all oriented parallel to the direction of travel of the positioning stage. The distance between the table plate and the base plate is just sufficient to accommodate the linear motor, the linear encoder, and the linear bearings.

Two of the above-described stages can be handily combined into small footprint X-Y positioning. A second small footprint mechanical positioning stage is arranged with its base plate affixed to the carriage plate of the first small footprint mechanical stage. Further, a small footprint X-Y-Z positioning stage can be assembled from two of the stages above described and a vertical left stage mounted on the carriage plate of the second small footprint mechanical stage.

A small footprint X-Y-Z-Theta positioning stage can be assembled from three of the above-described small footprint mechanical positioning stages by using two of the stages arranged on a foundation plate mounted with base plates thereof attached to edges of the foundation plate. A carriage plate parallel to the foundation plate bridges the carriage plates of the two small footprint mechanical positioning stages. The third small footprint mechanical positioning stage is mounted on the carriage plate oriented for travel perpendicular to the travel of the first and second small footprint mechanical positioning stages. A vertical lift stage is mounted on the carriage plate of the third small footprint mechanical positioning stage, and a rotary stage is mounted on the vertical lift stage. A five-axis small footprint positioning stage may be assembled by attaching a goniometric cradle mount to the rotary stage and a six-axis positioning stage may be assembled by attaching a double goniometric cradle to the rotary stage. This construction minimizes the vertical height of the four-, five- and six-axis stages. It is facilitated by the fact that the above-described small axis linear stages are capable of two perpendicular orientations.

### BRIEF DESCRIPTION OF THE DRAWINGS

Further features and other objects and advantages of this invention will become clear from the following detailed description made with reference to the drawings in which:

FIG. 1 is perspective view of a small footprint mechanical positioning stage, according to the present invention;

FIG. 2 illustrates two of the stages shown in FIG. 1 assembled into an X-Y positioning stage;

FIG. 3 is a top view of the stage shown in FIG. 1;

FIG. 4 is an end view of the stage shown in FIG. 3;

FIG. 5 is a view of a section taken along lines A-A in FIG. 3;

FIG. 6 is a view of a section taken along lines B-B in FIG. 3;

FIG. 7 is a side view of an X-Y-Z positioning stage wherein a vertical lift stage is mounted on top of two cross mounted small footprint mechanical positioning stages, according to the present invention;

FIGS. 8 and 9 are side and top views, respectively, of an X-Y-Z-Theta positioning stage assembled from three small footprint mechanical positioning stages, according to the present invention, two of which are set upon a narrow edge; and

FIG. 10 is a perspective view of a two-stage goniometer which may be fixed to the X-Y-Z-Theta positioning stage to provide a six-axis positioning stage.

### DESCRIPTION OF THE PREFERRED EMBODIMENTS

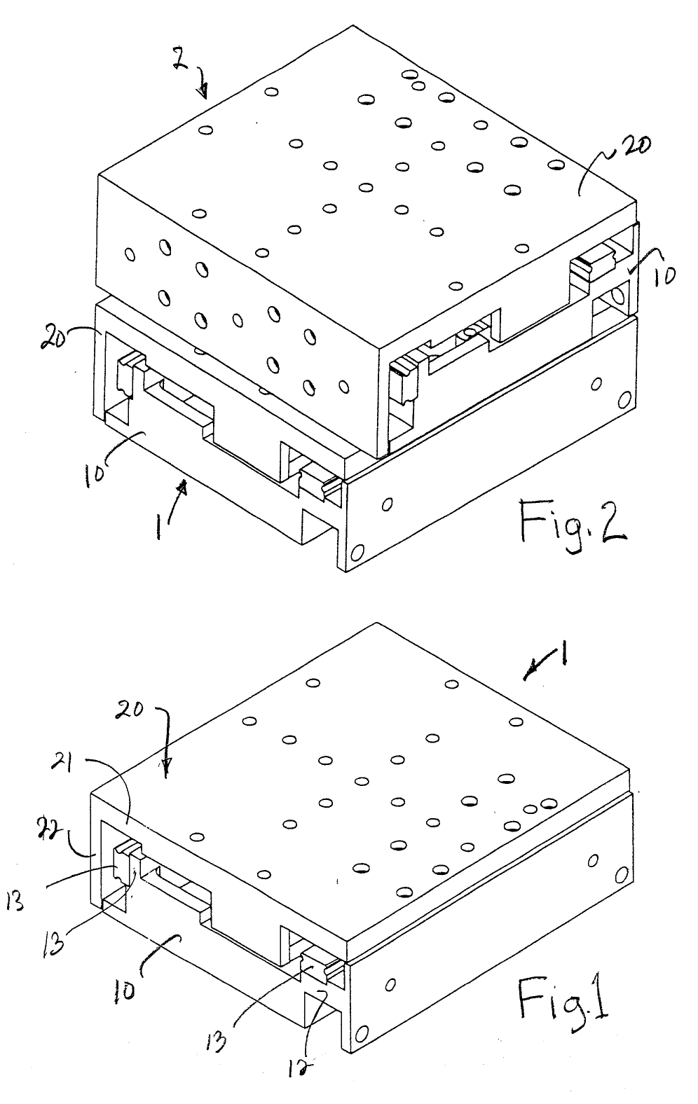

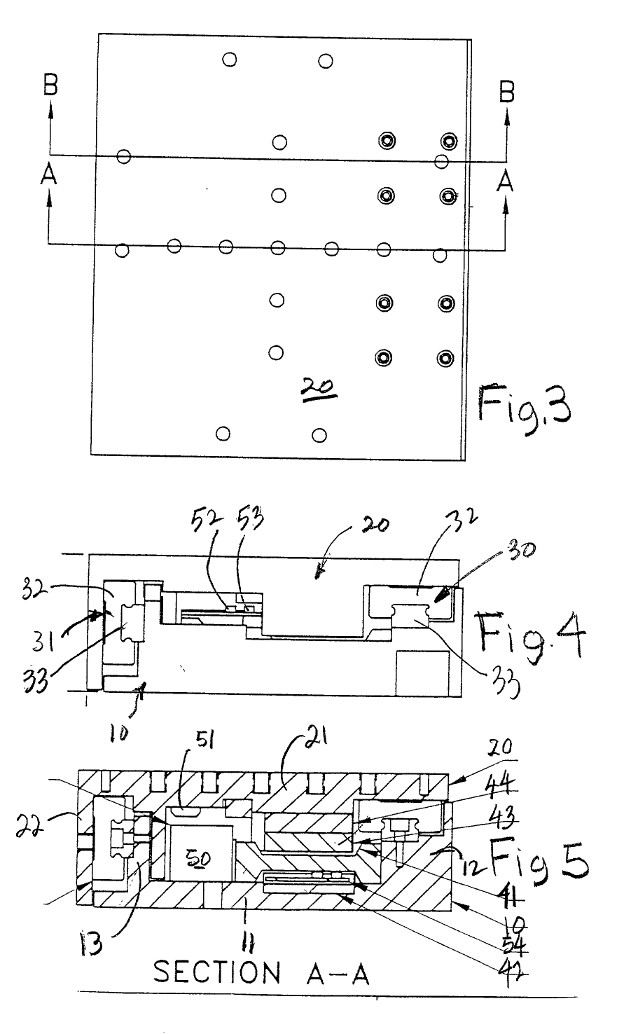

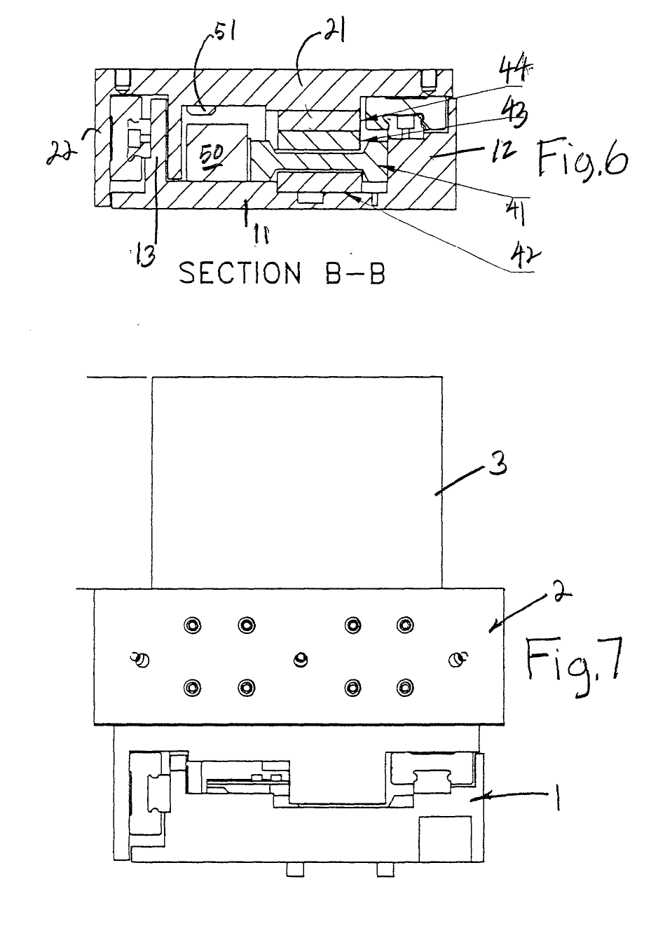

Referring now to FIG. 1, there is shown a perspective view of a small footprint mechanical positioning stage. The stage is comprised of a base plate 10 having a flat bed 11 (see FIGS. 4, 5 and 6) having two substantially parallel edges, a short raised platform 12 near one of the parallel edges of the flat bed 11, and a wall 13 spaced a short distance from the opposite edge of the flat bed 11 perpendicular thereto. Typically, the base plate 10 is machined from aluminum and aluminum alloys which are nonmagnetic and one-third as heavy as steel. The lighter weight reduces the inertia to be overcome by the linear motor. The positioning stage has a carriage plate 20 comprised of a table plate 21 and a perpendicular pendent side wall 22. Typically, the carriage plate 20 is machined from aluminum and aluminum alloys. The footprint of the positioning stage has been successfully reduced to 90×100 mm (3.542×3.937 inches). The total height of the stage is about 33 mm (1.299 inches). This compact size is made possible by the unique arrangement of the linear bearings and linear motor which connect and drive the base plate 10 relative to the carriage plate 20.

Referring to FIGS. 4, 5 and 6, a first linear bearing 30 (linear motion guide) is fixed between the table plate 21 and the raised platform 12. As shown in this particular embodiment, a rail 33 is attached to the underside of the table plate 21 and one or more slides 32 are attached to the raised platform 12. Suitable linear bearings are sold by THK LM Systems and have a design based upon balls bearing upon the rail 33 and that rotate in raceways in the slides 32. A second linear bearing is positioned between the wall rising from the flat bed 11 of the base plate 10 and the side wall 22 pendant from the table plate 21. As shown in this particular embodiment, the rail 33 is attached to the side wall 22 and one or more slides 32 are attached to the wall 13 rising from the flat bed 11. In this arrangement, the flat bed 11 and the table plate 21 are spaced sufficiently apart to accommodate a single-sided permanent magnet linear motor.

The linear motor comprises armature winding 41 fixed to the base plate with a magnetic focusing plate 42 between the armature winding 41 and the flat bed 11. A rare earth magnet track is fixed to the table plate 21 with a magnetic focusing plate 44 between the magnet track and the table plate 21. As the linear motor is a brushless linear motor that is electronically commutated, a Hall effect sensor 54 is mounted to generate commutation signals as the Hall effect sensors encounter the changing polarity of the magnet track.

According to a preferred embodiment of this invention, the armature winding is a three-phase slotless bifurcated winding, the magnetic pole pitch of the magnet track is less than about 16 mm, and the armature winding has a coil width of less than about 4 mm. The magnet track is at least 90 mm long and the armature winding is at least 60 mm long. In this configuration, with the rare magnets and the magnetic focusing plates, the positioning stage can move loads up to five kilograms a distance of 25 mm at the velocity of approximately 250 mm per second.

The linear position of the carriage is precisely controlled by feedback from a linear encoder. The linear encoder is positioned in the space between the flat bed 11 and the table plate 21 alongside of the linear motor. An encoder scale 51 is mounted on the underside of the table plate 21 parallel to the direction of travel. An encoder reader 50 is mounted below the encoder scale 51 on the flat bed 11. A home sensor 52 and limit switches 53 are mounted relative to the fiat bed 11. A suitable encoder comprises an RGH 22 read head manufactured by the Renishaw Company along with Renishaw's 20 micron RGS-S tape scale. This encoder reader-scale combination can provide an output resolution of 50 nm. By use of an encoder multiplier, such as the MX Series multipliers manufactured by Aeorotech, Inc. of Pittsburgh, Pa., the resolution of the stage position can be reduced to 20 nm and even to 10 nm. Calibrated accuracy of + or −0.5 microns and repeatability of 0.1 microns are thereby possible.

FIG. 2 illustrates how a small footprint X-Y positioning stage can be assembled from the above-described small footprint positioning stage. The second small footprint positioning stage 2 is arranged with its base plate 10 affixed to the carriage plate 20 of the first small footprint positioning stage 1.

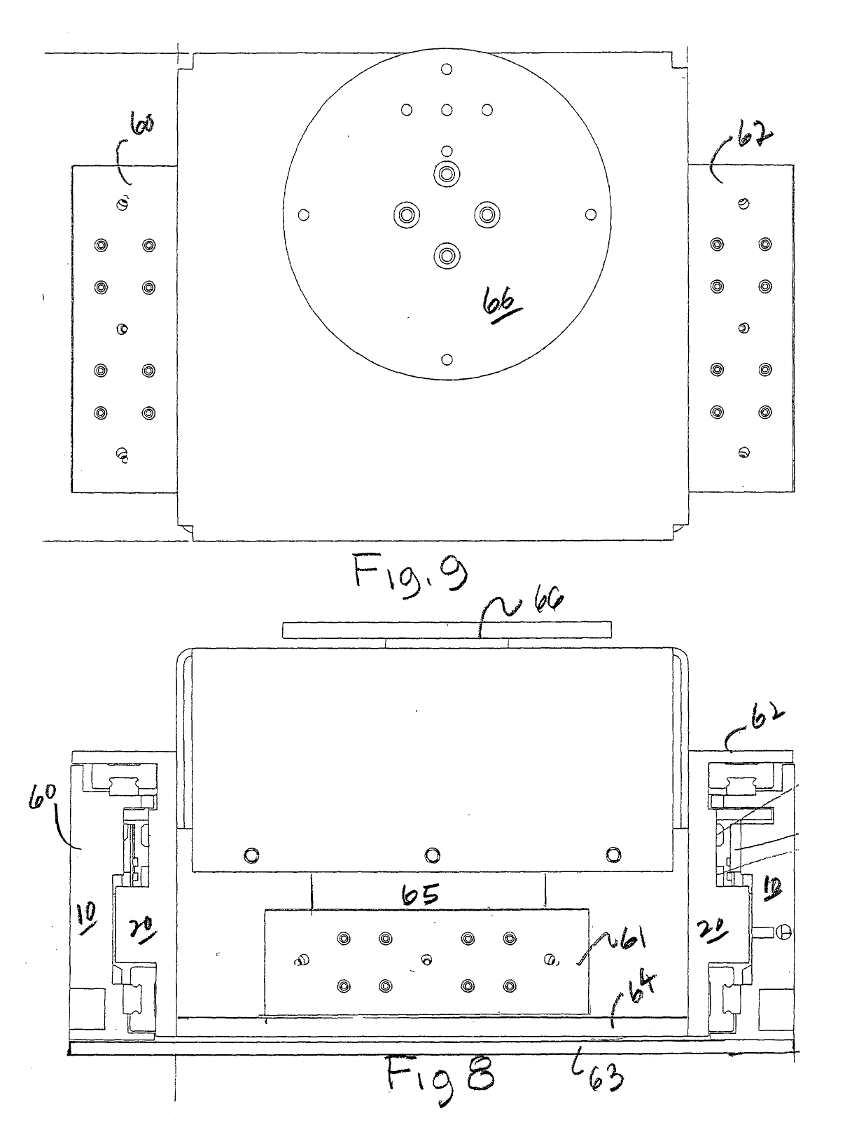

FIG. 7 illustrates a small footprint X-Y-Z positioning stage assembled from two of the above-described linear positioning stages, 1 and 2, with a vertical lift stage 3 mounted on the carriage plate of the second small footprint mechanical stage. A suitable vertical lift stage is described in an application entitled “Small Footprint Vertical Lift and Rotation Stage” filed on the same date herewith and assigned to a common assignee. That application is incorporated herein by reference.

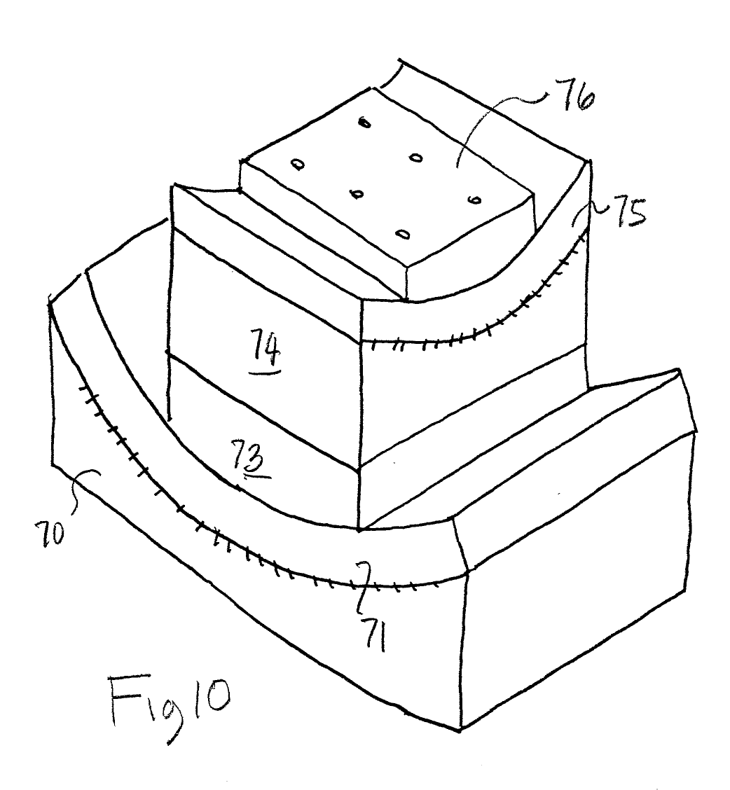

Referring to FIGS. 8 and 9, there is shown a small footprint X-Y-Z-Theta positioning stage assembled from three small footprint mechanical stages 60, 61 and 62. Stages 60 and 62 are arranged on a foundation plate 63 with the base plates 10 attached to the edges of the foundation plate 63. A carriage plate 64 bridges the carriage plates 20 of the stages 60 and 62. Centered on the carriage plate 64 is small footprint mechanical positioning stage 61. Stages 60 and 62 work together to provide the X motion and stage 61 provides the Y motion. Mounted atop the positioning stage 61 is vertical lift positioning stage 65 which has a rotary positioning stage 66 associated therewith. The vertical lift positioning stage 65 and associated rotary position stage 66 are described in the application referred to above.

Referring to FIG. 10, there is shown a double goniometric cradle which can be mounted to the rotary positioning stage 66 to provide a six-axis stage. The first goniometer has a base 70 with associated slide 71 and table 73. The second goniometer which is mounted on table 73 has a base 74 rotating slide 75 and table 76. The slides are driven relative to the base by brushless permanent magnet curvilinear motors with encoder feedback. Hence, in the six-axis stage, all stages are driven by brushless permanent magnet motors with encoder feedback enabling precise positioning.

Having thus described our invention with the detail and particularity required by the Patent Laws, what is desired protected by Letters Patent is set forth in the following claims.

What is claimed is:

1. A small footprint mechanical positioning stage capable of operating in two perpendicular orientations comprising:
a base plate comprising a flat bed, a short platform rising from the bed near one edge of the bed, and a short perpendicular wall rising from the bed near an opposite edge of the bed;
a carriage plate comprising a flat table plate and a short side wall pendent from the table plate near one edge of the table plate;
a first linear bearing between the base plate and the carriage plate fixed to the platform rising from the flat bed;
a second linear bearing between the base plate and the carriage plate fixed to the wall rising from the flat bed and the wall pendent from the table plate;
a brushless linear motor comprising an armature winding fixed to the base and a rare earth magnet track fixed to the table plate;
a linear encoder comprising an encoder reader fixed to the flat bed and an encoder scale fixed to the table plate;
the first and second linear bearings, the linear motor and the encoder scale all being parallel to the direction of travel of the positioning stage;
the distance between the table plate and the base plate being sufficient to accommodate the linear motor, the linear encoder and the linear bearings; and
whereby the first linear bearing provides maximum support in the direction perpendicular to the flat bed and the table plate and the second linear bearing provides maximum support in the direction between edges of the flat bed and table plate parallel to the direction of travel of the stage.

2. The positioning stage according to claim 1, further comprising a first magnetic focusing plate between the armature winding and the base plate and a second magnetic focusing plate between the magnet track and the table plate.

3. The positioning stage according to claim 1, further comprising a home sensor and limit switches.

4. The positioning stage according to claim 1, having a Hall effect sensor to travel with the carriage to generate commutation signals.

5. The positioning stage according to claim 1, wherein the armature winding is a three-phase bifurcated winding.

6. The positioning stage according to claim 1, wherein the magnetic pole pitch of the magnet track is less than about 16 mm.

7. The positioning stage according to claim 1, wherein the armature winding has a coil width of less than about 4 mm.

8. The positioning stage according to claim 1, wherein the linear encoder provides a resolution of at least 50 nm.

9. The positioning stage according to claim 1, wherein the encoder scale has a 20 micron pitch and is approximately 75 mm long.

10. The positioning stage according to claim 1, providing at least 20 mm travel.

11. The positioning stage according claim 9, wherein the armature winding is at least 60 mm long.

12. The positioning stage according to claim 9, wherein the magnet track is at least 90 mm long.

13. A small footprint X-Y positioning stage comprising:
a first small footprint mechanical positioning stage as described in claim 1; and
a second small footprint mechanical positioning stage as described in claim 1 with its base plate affixed to the carriage plate of the first small footprint mechanical stage.

14. A small footprint X-Y-Z positioning stage comprising:
a first small footprint mechanical positioning stage as described in claim 1;
a second small footprint mechanical positioning stage as described in claim 1 with its base plate affixed to the carriage plate of the first small footprint mechanical stage; and
a vertical lift stage mounted on the carriage plate of the second small footprint mechanical stage.

15. A small footprint X-Y-Z-Theta positioning stage comprising:
a base plate;
first and second small footprint mechanical positioning stages as described in claim 1 mounted with base plates thereof attached to edges of the base;
a carriage plate parallel to the base plate fixed to the carriage plates of the two small footprint mechanical positioning stages;
a third small footprint mechanical positioning stage as described in claim 1 mounted on the carriage plate oriented for travel perpendicular to the travel of the first and second small footprint mechanical positioning stages;
a vertical lift stage mounted on the carriage plate of the third small footprint mechanical positioning stage; and
a rotary stage driven by a brushless permanent magnet motor mounted on the vertical lift stage.

16. A five-axis small footprint positioning stage comprising:
a base plate;
first and second small footprint mechanical positioning stages as described in claim 1 mounted with base plates thereof attached to edges of the base;
a carriage plate parallel to the base plate fixed to the carriage plates of the two small footprint mechanical positioning stages;
a third small footprint mechanical positioning stage as described in claim 1 mounted on the carriage plate oriented for travel perpendicular to the travel of the first and second small footprint mechanical positioning stages;
a vertical lift stage mounted on the carriage plate of the third small footprint mechanical positioning stage;
a rotary stage driven by a brushless permanent magnet motor mounted on the vertical lift stage; and
a goniometer driven by a permanent magnet motor mounted on the rotary stage.

17. A six-axis small footprint positioning stage comprising the five-axis positioning stage of claim 15 with a second goniometer driven by a permanent magnet motor mounted on the goniometer.
